(19) United States
(12) Patent Application Publication
(10) Pub. No.: US 2026/0214389 A1
(43) Pub. Date: Jul. 23, 2026

(54) LOUDSPEAKER, LOUDSPEAKER SYSTEMS AND METHOD

(71) Applicant: PSS BELGIUM NV, Dendermonde (BE)

(72) Inventors: David CORYNEN, Dendermonde (BE); Fabian VUINE, Dendermonde (BE); Johan SCHEPENS, Dendermonde (BE)

(21) Appl. No.: 19/140,431

(22) PCT Filed: Dec. 18, 2023
(86) PCT No.: PCT/EP2023/086339

§ 371 Date: Jun. 18, 2025

(30) Foreign Application Priority Data
Dec. 22, 2022 (GB) 2219587.9

(51) Int. Cl. H04R 9/04; H04R 9/06

(52) U.S. Cl. CPC H04R 9/04; H04R 9/06

(57) ABSTRACT

There is provided a loudspeaker including a frame; a magnet unit to guide magnetic flux across an air gap; a diaphragm suspended from the frame; the diaphragm includes a neck portion forming a aperture; a voice coil assembly including a voice coil and a voice coil former; the voice coil former extends through the aperture such that a first gap is formed between the voice coil former and the neck portion of the diaphragm and a second gap is formed between the neck portion and the voice coil; a body of hardened adhesive occupies the first gap between the voice coil former and the neck portion and the second gap between the neck portion and the voice coil; the loudspeaker energises the voice coil to cause the voice coil assembly to move relative to the magnet unit along a movement axis, moving the diaphragm along the axis to produce sound.

This application claims priority to GB 2219587.9, filed 22 Dec. 2022.

### FIELD OF THE INVENTION

The present invention relates to a loudspeaker, loudspeaker systems and methods.

### BACKGROUND

A typical conventional loudspeaker has a frame, a diaphragm and a drive unit for the reproduction of sound. In use, the drive unit causes the diaphragm, which acts as a piston, to move backwards and forwards to generate pressure waves, i.e. sound.

The drive unit typically includes a magnet unit attached to the frame and a voice coil attached to the diaphragm. The magnet unit defines a magnetic circuit including an air gap across which magnetic flux is guided and in which the voice coil sits when at rest. By energising the voice coil, the magnet unit and the voice coil magnetically cooperate, i.e. magnetically interact, with each other to effect displacement of the combination of the voice coil and the diaphragm to thereby produce sound.

### SUMMARY OF THE INVENTION

The inventors observed that conventional fixing means of a voice coil in a loudspeaker may be insufficient for larger, heavier voice coils. Conventionally, a bead of adhesive is applied along a neck portion of a diaphragm fitted around a voice coil former to bond the diaphragm and the voice coil former. A clearance space between the neck portion and the voice coil former is small, such that the adhesive does not flow below the neck portion towards the voice coil, since otherwise it may interfere with the voice coil moving in an air gap of the loudspeaker.

Here is described a loudspeaker wherein adhesive joins the neck portion, the voice coil former and the voice coil for an improved means of securing the diaphragm to the voice coil former and the voice coil.

According to a first aspect of the invention, there is provided a loudspeaker including a frame; a magnet unit secured to the frame to guide magnetic flux across an air gap; a diaphragm suspended from the frame; wherein the diaphragm includes a neck portion forming a diaphragm aperture; a voice coil assembly including a voice coil and a voice coil former; wherein the voice coil former extends through the diaphragm aperture such that a first gap is formed between the voice coil former and the neck portion of the diaphragm and a second gap is formed between the neck portion and the voice coil; a body of hardened adhesive which occupies the first gap between the voice coil former and the neck portion of the diaphragm and the second gap between the neck portion and the voice coil; wherein the loudspeaker is operable to energise the voice coil to cause the voice coil assembly to move relative to the magnet unit along a movement axis, thereby moving the diaphragm along the movement axis to produce sound.

The loudspeaker according to the first aspect may be viewed as departing from accepted design principles, since the body of hardened adhesive occupies a space between the neck portion and the voice coil (in addition to a space between a neck portion and the voice coil former). As a result, an improved bond between the diaphragm and the voice coil former may be achieved.

The diaphragm may be suspended from the frame by at least a first suspension element and a second suspension element. The first suspension element may be attached to the frame at a first landing surface on the frame and the second suspension element is attached to the frame at a second landing surface on the frame.

The first suspension element may be provided as a surround. The first suspension element may attach directly or indirectly to the diaphragm. In some examples, the first suspension element may be secured to an outer edge of the diaphragm.

The second suspension element may be provided as a damper (which may be referred to as a “spider”). The second suspension element may attach directly or indirectly to the diaphragm. In some examples, the second suspension element may be secured to the diaphragm at a location inwardly located with respect to the outer edge of the diaphragm.

The centre of mass of the voice coil may have a position along the movement axis that is between the first landing surface and the second landing surface.

By suspending the voice coil from the frame such that the centre of mass of the voice coil is located between the first surround landing surface and the first damper landing surface, rocking may be inhibited. More particularly, the rocking modes of the loudspeaker may be pushed outside of the working frequency range of the loudspeaker.

The first gap may have a gap size measured in a direction perpendicular to the movement axis.

The gap size of the first gap may be at least 1 millimetre. By contrast, a traditional loudspeaker may have a gap size of no more than 0.3 millimetres to prevent adhesive from flowing therethrough.

The gap size of the first gap may in some examples be at most 50 percent of the winding thickness of the voice coil. Here, winding thickness is understood to describe the thickness of the windings of the voice coil and, e.g., may be measured in the direction perpendicular to the movement axis.

The second gap may have a gap size measured in a direction parallel to the movement axis.

The gap size of the second gap may be between 0 and 5 millimetres. By contrast, a traditional loudspeaker may have a gap size exceeding 5 millimetres due to a large separation of the neck portion and the voice coil along the movement axis.

The diaphragm may include, in addition to the neck portion, an inner diaphragm portion and a curved segment between the neck portion and the inner diaphragm portion.

The curved segment, when viewed in in a direction perpendicular to the movement axis, may have a radius of curvature between 2 and 10 millimetres.

The neck portion, when viewed in a direction perpendicular to the movement axis, may be straight.

The curved segment may have a first length measured along the diaphragm and perpendicular to the movement axis. The neck portion may have a second length measured along the diaphragm and perpendicular to the movement axis. The first length may be greater than the second length.

The diaphragm may further include an outer diaphragm portion, wherein the inner diaphragm portion is between the curved segment and the outer diaphragm portion.

The body of hardened adhesive may have a volume dependent on the size of the voice coil. For example, the volume of the body may be 30 cubic millimetres to 100 cubic millimetres per millimetre of voice coil diameter.

In some examples, the body may have a volume in a range of 750 cubic millimetres to 2500 cubic millimetres.

A first loudspeaker as described above and a second loudspeaker as described above may be provided as a loudspeaker system, wherein the first loudspeaker and the second loudspeaker are arranged in a back-to-back configuration such that the first loudspeaker and the second loudspeaker face in opposite directions.

The loudspeaker system may be operable to energise the voice coil of the first loudspeaker and the voice coil of the second loudspeaker to cause the voice coil of the first loudspeaker and the voice coil of the second loudspeaker to move along the movement axis in opposite directions, thereby moving the diaphragm of the first loudspeaker and the diaphragm of the second loudspeaker to produce sound.

Providing the ‘back-to-back’ loudspeaker system, particularly in a small housing, may further increase pressure experienced by the loudspeakers in operation, hence further increasing forces acting on the diaphragm and the voice coil. However, the body of hardened adhesive as described above may be suitable for withstanding such forces and preventing separation of the diaphragm and the voice coil assembly.

According to another aspect of the invention, there is provided a method of manufacturing a moving assembly for a loudspeaker.

The method includes providing a voice coil assembly including a voice coil former and a voice coil; providing a diaphragm including a neck portion forming a diaphragm aperture; fitting the diaphragm onto the voice coil assembly by inserting the voice coil former through the diaphragm aperture; curing a portion of adhesive to form a body of hardened adhesive which occupies a first gap between the voice coil former and the neck portion of the diaphragm and a second gap between the neck portion and the voice coil so as to attach the neck portion of the diaphragm to the voice coil former.

The method may include fitting the diaphragm onto the voice coil assembly followed by applying a bead of (unhardened) adhesive at a gap formed between the voice coil former and the neck portion (then subsequently curing the adhesive).

The method may include applying a bead of (unhardened) adhesive along a junction formed between the voice coil former and the voice coil, then fitting the diaphragm onto the voice coil assembly (then subsequently curing the adhesive).

The inventors observed that lead wires supplying an electrical signal to a voice coil may, when the loudspeaker is in operation, leave the confines of the loudspeaker frame where this frame is ‘open’, i.e. provided with at least one aperture through which the flexible lead wire can move during negative displacement. The inventors further observed that this may be a particular issue for a loudspeaker system with loudspeakers arranged in back-to-back configuration, since in such a case it can be expected for the lead wires to touch each other during operation. This may eventually cause a short circuit or amplifier malfunction. With a view to preventing this, the lead wires are preferably orientated such that they are offset when viewed in a plane perpendicular to the movement axis.

According to a second aspect of the invention, there is provided a loudspeaker system including a first loudspeaker comprising: a first frame having a back side and a front side, wherein the first frame has a plurality of first apertures which extend from the front side to the back side of the first frame; a first diaphragm suspended from the first frame on the front side of the first frame; a first drive unit, wherein the first drive unit includes a stationary part attached to the first frame and a translatable part, and the translatable part of the first drive unit is attached to the first diaphragm to form a first moving assembly; and at least two first lead wire portions configured to transmit an electrical signal between the first drive unit and a signal source; wherein, when the first loudspeaker is at rest, the at least two first lead wire portions extend between the first diaphragm and the first frame; a second loudspeaker comprising: a second frame having a back side and a front side, wherein the second frame has a plurality of second apertures which extend from the front side to the back side of the second frame; a second diaphragm suspended from the second frame on the front side of the second frame; a second drive unit, wherein the second drive unit includes a stationary part attached to the second frame and a translatable part, and the translatable part of the second drive unit is attached to the second diaphragm to form a second moving assembly; and at least two second lead wire portions configured to transmit an electrical signal between the second drive unit and the signal source; wherein, when the second loudspeaker is at rest, the at least two second lead wire portions extend between of the second diaphragm and the second frame; wherein the loudspeaker is operable to energise the first drive unit and the second drive unit to cause the first moving assembly and the second moving assembly to move along a movement axis in opposite directions to produce sound; and wherein all of the first lead wire portions are offset from all of the second lead wire portions when viewed in a plane perpendicular to the movement axis.

In this way, the first lead wire portions avoid overlapping the second lead wire portions when viewed in a plane perpendicular to the movement axis, which helps to avoid a scenario in which the first lead wire portions touch the second lead wire portions during operation.

Each of the two first lead wire portions may terminate at a respective first terminal on the first frame. Each of the two second lead wire portions may terminate at a respective second terminal on the second frame. Each of the first and second terminals may be offset from all other of the first and second terminals by an angle of at least 10 degrees, preferably at least 20 degrees, measured relative to the movement axis when viewed in a plane perpendicular to the movement axis.

Each of the first terminals may be offset from each of the second terminals by an angle of at least 90 degrees when viewed in a plane perpendicular to the movement axis.

There may be exactly two first lead wire portions and exactly two second lead wire portions.

The inventors observed that enlarging the outer size of the diaphragm in one direction, e.g. a racetrack loudspeaker, or in all direction, e.g. a round loudspeaker, then the outer diaphragm angle will decrease, thereby reducing geometrical stiffness of the diaphragm and in use possibly interfering with the second suspension element. To compensate, one could make the loudspeaker taller but this is clearly not preferable where a shallow loudspeaker is desired.

As a solution, the inventors provide an arch portion (or “bulge”) in the outer diaphragm body. The arch portion is preferably located where interference with the second suspension element would occur during operation. In addition to solving the issue with possible interference with the second suspension element, this also serves to reinforce the diaphragm.

According to a third aspect of the invention, there is provided a loudspeaker system comprising: a first loudspeaker including: a first frame having a front side facing in a first direction and a back side facing in a second direction; a first diaphragm suspended from the first frame on the front side of the first frame by at least a first suspension element and a second suspension element, wherein the second suspension element is located between the first frame and the first diaphragm; a first drive unit including a first stationary part attached to the first frame, and further including a first translatable part attached to the first diaphragm to form a first moving assembly; wherein the first diaphragm has a first radiating surface facing in the first direction and a second radiating surface facing in the second direction; wherein the first diaphragm includes a first arch portion which extends in the first direction and is configured such that the underside of the first arch portion is configured to avoid contact with the second suspension element by arching over the second suspension element when the first diaphragm is at its maximum extent in the second direction when the loudspeaker system is in use; a second loudspeaker including: a second frame having a front side facing in the second direction and a back side facing in a first direction; a second diaphragm suspended from the second frame on the front side of the second frame by at least a third suspension element and a fourth suspension element, wherein the fourth suspension element is located between the second frame and the second diaphragm; a second drive unit including a second stationary part attached to the second frame, and further including a second translatable part attached to the second diaphragm to form a second moving assembly; wherein the second diaphragm has a first radiating surface facing in the second direction and a second radiating surface facing in the first direction; wherein the second diaphragm includes a second arch portion which extends in the second direction and is configured such that the underside of the second arch portion is configured to avoid contact with the fourth suspension element by arching over the fourth suspension element when the second diaphragm is at its maximum extent in the first direction when the loudspeaker system is in use; wherein the loudspeaker is operable to energise the first drive unit and the second drive unit to cause the first moving assembly and the second moving assembly to move along a movement axis in opposite directions to produce sound.

In accordance with any aspect of the invention, a stationary part of a drive unit (e.g. a magnet unit) or a translatable part of a drive unit may include a permanent magnet. The permanent magnet may have a smaller mass than the mass of the voice coil. That is to say, the permanent magnet may have a first mass, the voice coil may have a second mass, and the first mass may be smaller than the second mass. The first mass may be smaller than the second mass by at least a factor of two, or even by at least a factor of 2.5, for example by a factor of 2.8

In accordance with any aspect of the invention, a magnet unit (which may serve as a stationary part of a drive unit) and an air gap may form a magnetic circuit. The magnetic circuit may provide a substantially closed circuit (or loop) for the magnetic flux that is generated by the permanent magnet and is guided by the at least two flux guiding elements.

The magnetic circuit may have a comparatively high magnetic reluctance. In particular, the magnetic reluctance may exceed the magnetic reluctance of a conventional magnet unit, which is typically kept low. For example, the magnetic reluctance of the magnetic circuit may be at least 2.5×10\hat{ }6 [1/H] or even 3×10\hat{ }6 [1/H], where “H” represents the physical unit “Henry”. By contrast, a conventional magnet unit may have a magnetic reluctance of at most 1.5×10\hat{ }6 [1/H]. Thus, the magnetic reluctance according to the present disclosure corresponds to, or exceeds, 166% or even 200% of the magnetic reluctance of a more conventional magnetic unit.

The majority of the magnetic reluctance of the magnetic circuit may be attributed to the air gap. For example, the air gap may have a magnetic reluctance of at least 2×10\hat{ }6 [1/H].

By utilising a magnetic circuit with high magnetic reluctance, and particularly a high-reluctance air gap, it is possible to utilise comparatively small flux guiding elements. Thus, it is possible to reduce the weight of the magnet unit. This weight reduction of the magnet unit may more than compensate for the weight of a large voice coil, meaning that the comparatively high magnetic reluctance of the magnetic circuit enables designing of particularly lightweight loudspeakers. Such considerations may be relevant especially for applications in, for example, the automobile industry.

The loudspeaker according to the first aspect or the loudspeaker system according to the second or third aspect may be configured to produce sound with frequencies in a bass frequency range. The bass frequency range may include 60-80 Hz, where “Hz” represents the physical unit “Hertz”. More preferably, the bass frequency range may include 40-100 Hz. By way of example, the bass frequency range may be 20 Hz-100 Hz.

In accordance with any aspect of the invention, a separation between the first and second landing surfaces may be defined as a distance between a location on the first landing surface and a location on the second landing surface as measured in direction parallel to the movement axis.

An extent of the voice coil as measured in direction parallel to the movement axis (or ‘height’ of the voice coil) may be in a range of 85% and 100% of the separation between the first and second landing surfaces as measured in direction parallel to the movement axis. This configuration may enable large linear displacement of the voice coil while effectively inhibit rocking motion.

The loudspeaker according to the first aspect or the loudspeaker system according to the second or third aspect may be provided in an automobile. More particularly, the loudspeaker or loudspeaker system may be provided at a footwell or under the seat of the automobile, or indeed in any other location suitable for packaging a bass loudspeaker system in the automobile.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1 is a cross-sectional view of a loudspeaker designed according to principles believed to be known.

FIG. 2 is an enlarged view of a portion of FIG. 1.

FIG. 3 is a cross-sectional view of an exemplary loudspeaker.

FIG. 4 is another cross-sectional view of part of the loudspeaker of FIG. 3.

FIG. 5 is an enlarged view of a portion of FIG. 3.

FIG. 6 illustrates a method of manufacture.

FIG. 7 is a cross-sectional view of an exemplary loudspeaker system including a pair of loudspeakers of FIG. 3, shown at rest.

FIG. 8 is another cross-sectional view of the exemplary loudspeaker system, shown at maximum negative displacement.

FIG. 9 is a perspective view of another exemplary loudspeaker.

FIG. 10 shows the front side of the loudspeaker of FIG. 9.

FIG. 11 is a first sectional view of the loudspeaker of FIG. 9.

FIG. 12 is a second sectional view of the loudspeaker of FIG. 9.

FIG. 13 is a combined cross-sectional view of the loudspeaker of FIG. 9, showing in combination (part of) the sections of FIGS. 10 and 11.

FIG. 14 shows the rear side of the loudspeaker of FIG. 9.

FIG. 15 is a cross-sectional view of a loudspeaker system incorporating the loudspeaker of FIG. 9.

FIG. 16 is another cross-sectional view of the loudspeaker system of FIG. 16.

FIG. 17 is a perspective view of another exemplary loudspeaker.

FIG. 18 is another perspective view of the loudspeaker of FIG. 17.

FIG. 19 is a front view of the loudspeaker of FIG. 17.

FIG. 20 shows another exemplary loudspeaker system.

FIG. 21 shows an exemplary application of the loudspeaker system of FIG. 3.

### DETAILED DESCRIPTION OF THE INVENTION

Aspects and embodiments of the present invention will now be discussed with reference to the accompanying figures. Further aspects and embodiments will be apparent to those skilled in the art.

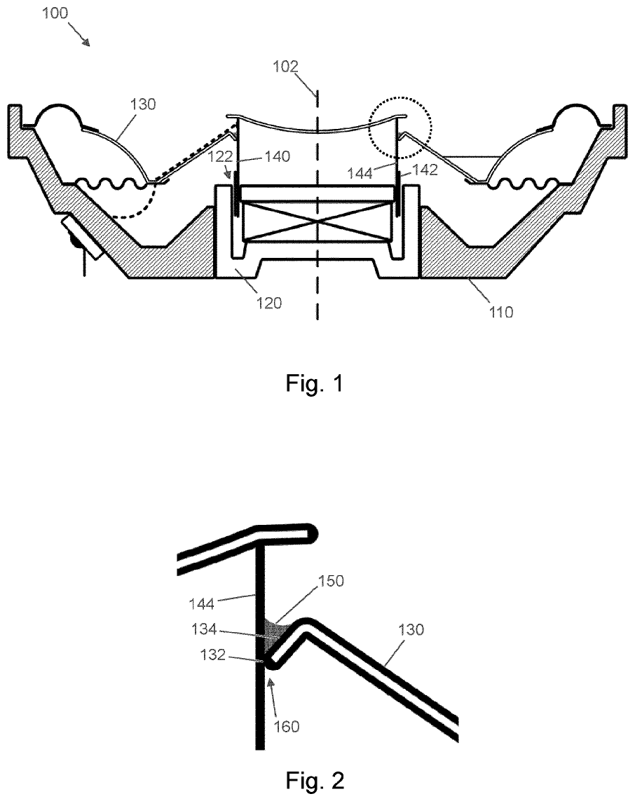

FIGS. 1 and 2 illustrate a loudspeaker 100 designed by the inventors according to what the inventors believe to be known design principles. FIG. 1 is a cross-sectional view of the loudspeaker 100, while FIG. 2 is an enlarged view of a particular section of FIG. 1 (indicated in FIG. 1 by a dotted circle).

The loudspeaker 100, herein referred to also as a traditional loudspeaker, comprises a frame 110, a magnet unit 120, a diaphragm 130, a voice coil assembly 140. The voice coil assembly 140 includes a voice coil 142 and a voice coil former 144.

In use, the magnet unit 120 and the voice coil 142 magnetically cooperate, i.e. magnetically interact, with each other to effect displacement a moving assembly, which includes the diaphragm 130 and the voice coil assembly 140, along a movement axis 102. Suitably, the diaphragm 130 and the voice coil assembly 140 are joined together such that in use they move together ‘as a unit’.

In FIG. 2, a bead of cured adhesive 150 is shown by means of which the diaphragm 130 and the voice coil assembly 140 are joined together. More particularly, an inner cone edge 132 fits closely to the voice coil former 144 so that when the adhesive 150 is applied to fix the diaphragm 130 to the voice coil assembly 140, the bead of adhesive 150 rests on an inner cone neck 134 against the voice coil former 144 and does not flow through a narrow gap 160 between the inner cone neck 134 and the voice coil former 144. The gap 160 may typically have a size of less than 0.3 millimetres, measured in a direction perpendicular to the movement axis 102. This size, in combination with adhesive of appropriate viscosity (e.g. not watery), prevents the adhesive from flowing or dripping below the gap 160. Also, a chamfer of the inner cone neck 134 allows for a close fit to the voice coil former 144 so that the bead of adhesive 150 rests on the inner cone neck 134 against the voice coil former 144 and does not flow below the narrow gap 160. According to design principles which may be commonly accepted in the art, this may need to be prevented because if adhesive were to drip onto the voice coil 142, such adhesive could block the voice coil 142 from moving freely in an air gap 122 formed by the magnet unit 120. At the same time, an improved bond between the diaphragm 130 and the voice coil assembly 140 may be desirable.

Considering a loudspeaker unit that incorporates a voice coil with many winding layers, e.g. 10 or more, for enhanced motor force, the voice coil mass will be significantly higher. Therefore, the voice coil may need to be fixed “rock solid” to the diaphragm since the forces acting on it may be of a different magnitude as compared to traditional loudspeakers and their application. Moreover, where those loudspeaker units are mounted back-to-back in very small housings, the pressure inside the box may increase further, meaning the forces acting on the diaphragm and voice coil also increase further.

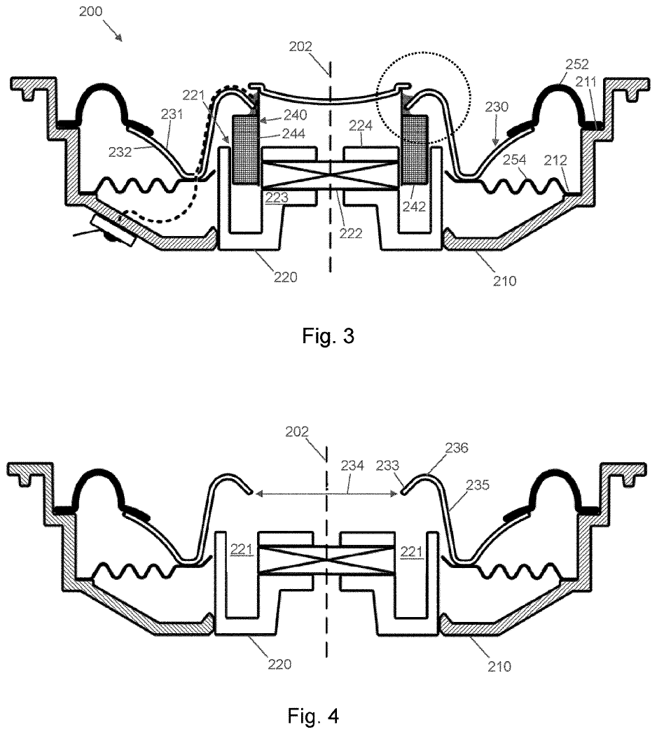

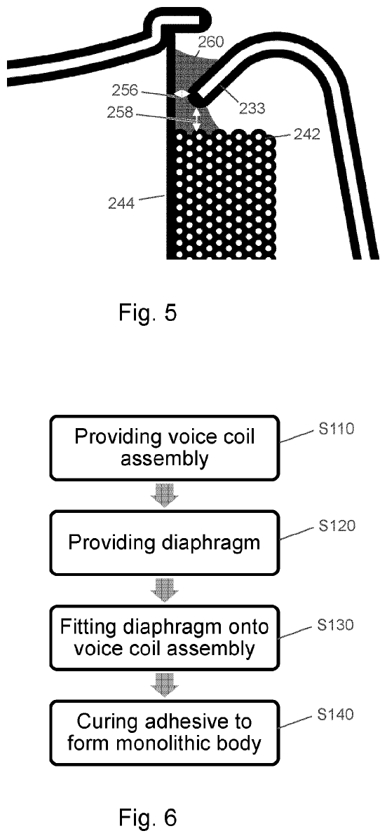

FIGS. 3, 4 and 5 show an exemplary loudspeaker 200. FIG. 3 is a cross-sectional view of the loudspeaker 200. FIG. 4 is the same cross-sectional view, but some structural features are not shown for convenience of illustration. FIG. 5 is an enlarged view of a particular section of FIG. 3 (indicated by a dotted circle). The loudspeaker 200 includes a frame 210, a magnet unit 220, a diaphragm 230, and a voice coil assembly 240. The voice coil assembly 240 includes a voice coil 242 and a voice coil former 244.

The diaphragm 230 is suspended from the frame 210 by at least a first suspension element 252 and a second suspension element 254. The first suspension element 252 is attached to the frame 210 at a first landing surface 211 on the frame 210 and the second suspension element 254 is attached to the frame 210 at a second landing surface 212 on the frame 210. In some examples, the first suspension element 252 has a thickness between 0.5 millimetres and 1 millimetre, which may help to prevent buckling during operation when installed in a very small acoustic volume.

The first suspension element 252 and the second suspension element 254 are secured to the diaphragm 230 such that the centre of gravity of the voice coil 242 is located between the first landing surface 211 and the second landing surface 212. More particularly, the voice coil 242 is configured to sit in the air gap 221 when the diaphragm 130 is at rest, with the centre of mass of the voice coil 242 having a position along the movement axis 202 that is between the first landing surface 211 and the second landing surface 212.

The loudspeaker 200 is operable to energise the voice coil 242 to cause the voice coil 242 to move along the movement axis 202 relative to the magnet unit 220. The voice coil 242 is rigidly connected to the diaphragm 130, such that the voice coil 242 and the diaphragm 230 move together as a moving assembly. When causing the voice coil 242 to move along the movement axis 202, the diaphragm 230 also moves along the movement axis 202, thereby producing sound.

More particularly, the diaphragm 230 has a first sound radiating surface 231 and a second sound radiating surface 232. The first sound radiating surface 231 faces in a forward direction (away from the frame 210) and in use is utilised for producing sound. The second sound radiating surface 232 faces in a rearward direction, i.e. into the frame 210. The forward direction and the rearward direction are opposite directions parallel to the movement axis 202, while a direction perpendicular to the movement axis 202 is also referred to as a radial direction.

The magnet unit 220 is secured to the frame 210 and guides magnetic flux across an air gap 221. The magnet unit 220 includes a permanent magnet 222 and at least two flux guiding elements 223, 224 configured to guide the magnetic flux across the air gap 221. The flux guiding elements 223, 224 are provided as a (magnetic) yoke 223 and a (magnetic) washer 224. The permanent magnet 222 is provided as a rare earth magnet and may comprise more than one structural element. In some examples, the permanent magnet 222 and the flux guiding elements are axially symmetric about the movement axis 202, though other arrangements are possible.

The permanent magnet 222 has a mass which is smaller than the mass of the voice coil 242. In some examples, the mass of the voice coil 242 is greater than the mass of the permanent magnet 222 by a factor of two, i.e. the mass of the voice coil 242 is two times greater than the mass of the permanent magnet 222. In some examples, the mass of the voice coil 242 is approximately 1.75 times greater than the mass of the permanent magnet 222. The magnet unit 220 and the air gap 221 form a magnetic circuit. The magnetic circuit provides a closed loop for the magnetic flux that is generated by the permanent magnet 222 and is guided by the two flux guiding elements 223, 224 across the air gap 221. In some examples, the air gap 221 has a magnetic reluctance of 5.3×10\hat{ }6 [1/Henry] and the magnetic circuit has a total magnetic reluctance slightly greater than the magnetic reluctance of the air gap 221. The loudspeaker 200 makes use of a comparatively large voice coil 242 using many layers in the magnetic circuit. This makes the air gap 221 wider to accommodate the larger voice coil 242 as compared to a traditional loudspeaker, and the total reluctance in the magnetic circuit increases.

This configuration leads to a comparably high voice coil mass and comparatively low magnet unit mass. Yet the overall mass of the drive unit may be lower than, for example, for the aforementioned known loudspeakers. A ratio of moving mass to total mass may be approximately 1:4. For example, the ratio of moving mass to total mass may be approximately 40 grams:160 grams. In some examples, the ratio may be in a range of 1:4 and 1:3, preferably 1:4 and 1:2. Also, a ratio of magnet mass to voice coil winding mass of 1:2, preferably up to 1:4, can be reached. This leads to a surprisingly lightweight bass loudspeaker with low resonance frequency in box.

Considering that the voice coil 242 has a comparatively large number of winding layers, its mass is significantly higher than in the traditional loudspeaker 100. Accordingly, the connection between the voice coil assembly 240 and the diaphragm 230 is improved to prevent forces acting on the moving assembly during operation from damaging the moving assembly.

In some examples, the diaphragm 330 is made from paper and preferably has a thickness between 0.5 millimetres and 1 millimetre. By contrast, conventionally the thickness of a paper diaphragm may be 0.5 millimetres or less.

The diaphragm 230 includes a neck portion 233 forming a diaphragm aperture 234. The neck portion 233 is (when viewed in cross-section) a straight segment of the diaphragm 230. The diaphragm 230 further includes an inner diaphragm portion 235 and a curved portion 236 (or ‘curved segment’). The inner diaphragm portion 235 is another segment of the diaphragm 230 which (in cross-section) is straight. The curved portion 236 is located between and connects the neck portion 233 and the inner diaphragm portion 235, and (in cross-section) is curved.

The inner diaphragm portion 235 is preferably at an angle of less than 15 degrees with respect to the movement axis 202 of the loudspeaker 200, in some examples less than 10 degrees. Thus, the dimensions of the second suspension element 200 can be maximized for a given loudspeaker size, contributing to achieving a linear suspension.

The voice coil former 244 extends through the diaphragm aperture 234 such that a first gap 256 is formed between the voice coil former 244 and the neck portion 233 of the diaphragm 230. Also, a second gap 258 is formed between the neck portion 233 and the voice coil 242.

A body 260 of hardened adhesive which occupies the first gap 256 between the voice coil former 244 and the neck portion 233 of the diaphragm 230 and the second gap 258 between the neck portion 233 and the voice coil 242 so as to attach the neck portion 233 of the diaphragm 230 to the voice coil former 244. The body 260 may occupy the entire first gap 256 and/or the entire second gap 258, i.e. fill either or both gaps 256, 258. In some examples, the body 260 may not be bonded to the voice coil 242, which in use may get very hot such that a bond between the body 260 of hardened adhesive and the voice coil 242 may be damaged. Nevertheless, the bond between the diaphragm 230 and the voice coil former 244 may be improved over the traditional loudspeaker 100.

In some examples, the curved portion 236 of the diaphragm 230 has a radius of curvature between 2 and 10 millimetres. Preferred radii may be at least 2 mm, preferably between 3 mm and 5 mm or even larger. A larger radius may help to reinforce the diaphragm 230 in the region of the neck portion 233, which may be especially desirable where the diaphragm 230 is made from paper. The inventors observed that sharp corners may weaken the diaphragm 230, since there the paper fibres may not flow homogeneously when forming the diaphragm. This may create a weak spot/region.

The curved portion 236 has a first length which is measured along the diaphragm 230 and perpendicular to the movement axis 202, while the neck portion 233 has a second length which is measured along the diaphragm 230 and perpendicular to the movement axis 202. In some examples, the first length is greater than the second length. That is to say, according to some examples in cross-section a greater length of the diaphragm 230 makes up the curved portion 236 than the straight section that is the neck portion 233.

The body 260 of hardened adhesive, e.g. a monolithic body of hardened/cured adhesive, therefore occupies a volume of space both above and below the neck portion 233. More particularly, the body 260 of hardened adhesive extends all the way to the voice coil 242 (even if in use not bonded to the voice coil 242). As such, a greater volume of adhesive is provided than in the traditional loudspeaker 100 described above. Moreover, the volume of adhesive is both above and below the neck portion 233, whereas in the case of the traditional loudspeaker 100 the adhesive may be exclusively on the diaphragm 130.

In some examples, the first gap 256 has a gap size measured in a direction perpendicular to the movement axis 202 which is at least 1 millimetre. In some examples, the gap size of the first gap is at most 50 percent of the winding thickness of the voice coil 242. Here, winding thickness is understood to describe the thickness of the windings of the voice coil 242 and, in FIG. 3, would be measured in the direction perpendicular to the movement axis 202.

In some examples, the second gap 258 has a gap size measured in a direction parallel to the movement axis 202 which is between 0 and 5 millimetres. Here it is noted that the diaphragm 230 may be arranged to rest on (or almost rest on) the voice coil 242 whilst being embedded in the body 260 of hardened adhesive, such that even with the gap size of 0 millimetres an embedded neck portion 233 is obtained.

FIG. 6 illustrates a method of manufacturing a moving assembly as described with reference to FIGS. 3 to 5. More particularly, this is a method of bonding the diaphragm 230 and the voice coil assembly 240 using suitable adhesive. Suitable choices of adhesive are known in the art and therefore not described further.

A first step S110 of the method involves providing the voice coil assembly 240 and a second step S120 involves providing the diaphragm 230. Here, the voice coil assembly 240 and the diaphragm 230 are separate. Generally, steps S110 and S120 may be carried out in either order and may be carried out together.

A third step S130 involves fitting the diaphragm 230 onto the voice coil assembly 230 by inserting the voice coil former 244 through the diaphragm aperture 234 enclosed by the neck portion 233 of the diaphragm 230.

A fourth step S140 involves curing a portion of adhesive to form the body 260 of hardened adhesive. The body 260 occupies the first gap 256 between the voice coil former 244 and the neck portion 233 of the diaphragm 230 and the second gap 258 between the neck portion 233 and the voice coil 242 so as to attach the neck portion 233 of the diaphragm 230 to the voice coil former 244.

In some examples, the adhesive is applied before fitting the diaphragm 230 to the voice coil assembly 240. According to such examples, fitting the diaphragm 230 onto the voice coil assembly 240 is preceded by applying a bead of adhesive along a junction formed between the voice coil former 244 and the voice coil 242. The junction formed between the voice coil former 244 and the voice coil 242 is an internal corner defined by the voice coil former 244 and the voice coil 242.

In some examples, the adhesive is applied after fitting the diaphragm 230 to the voice coil assembly 240. According to such examples, fitting the diaphragm 230 onto the voice coil assembly 240 is followed by applying a bead of adhesive at the first gap 256 formed between the voice coil former 244 and the neck portion 233, thereby bridging the neck portion 233, the voice coil former 244 and the voice coil 242.

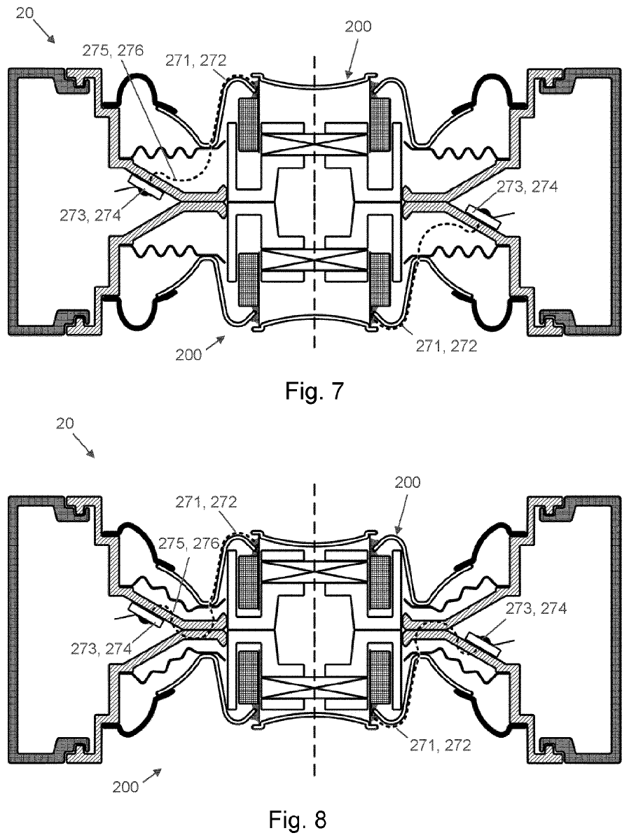

FIGS. 7 and 8 illustrate a loudspeaker system 20 including two loudspeakers 200 as described above. FIG. 7 is a cross-sectional view of the loudspeaker system 20 at rest, while FIG. 8 is a cross-sectional view showing the loudspeaker system 20 at maximum negative displacement.

The loudspeaker 200 as described above may be provided as part of a system wherein multiple loudspeakers 200 are provided in a force-cancelled arrangement. As shown in FIGS. 7 and 8, the loudspeaker system 20 includes a first loudspeaker 200 and a second loudspeaker 200 in back-to-back configuration such that the first loudspeaker 200 and the second loudspeaker 200 face in opposite directions. The loudspeaker system 20 is operable to energise the voice coil 242 of the first loudspeaker 200 and the voice coil 242 of the second loudspeaker 200 to cause the magnet unit 220 of the first loudspeaker 200 and the magnet unit 220 of the second loudspeaker 200 to move along the movement axis 202 in opposite directions, thereby moving the diaphragm 230 of the first loudspeaker 200 and the diaphragm 230 of the second loudspeaker 200 to produce sound.

Each loudspeaker 200 includes a pair of lead wires 271, 272 (dashed line) terminating at a respective terminal 273, 274. In FIGS. 7 and 8 only a single lead wire 271, 272 is visible for each loudspeaker 200, and similarly only a single terminal 273, 274 is visible for each loudspeaker 200.

The lead wires 271, 272 in the loudspeakers 200 are conveniently routed towards the back of the diaphragm 230 and the second suspension element 254, because there may be more space to allow for placement and flexing of the lead wires 271, 272 during excursion. Thus a portion of the lead wires 271 272 extends between the diaphragm 230 and the frame 210 for each loudspeaker 200. In this way, a very shallow loudspeaker system 20 can be constructed. However, in this configuration the portions of the lead wires 271, 272 between the diaphragm 230 and the frame 210 will potentially move outside the contours of the loudspeaker 200 during maximum excursion, where the back of the frame 210 of the loudspeaker 200 is open. When mounting the loudspeakers 200 back-to-back without accounting for such displacement of the lead wires 271, 272, one can expect lead wires 271, 272 from the two loudspeakers 200 to touch each other during operation. This may eventually cause a short circuit or amplifier malfunction. To prevent this, the loudspeakers 200 are orientated such that their respective lead wires 271, 272 do not meet in use. In FIGS. 7 and 8, both loudspeakers 200 are oriented such that their respective lead wire positions are opposite each other. That is to say, the lead wires 271, 272 and corresponding terminals 273, 274 are oriented by 180 degrees from each other. More generally, any relative angular offset of one driver in respect to the other is possible so that contact between lead wires 271, 272 of both loudspeakers 200 during operation is prevented (e.g., 10 degrees, 90 degrees). When so orientated, all of the lead wires 271, 272 of the first loudspeaker 200 are offset from all of the lead wires 271, 272 of the second loudspeaker 200 when viewed in a plane perpendicular to the movement axis 202.

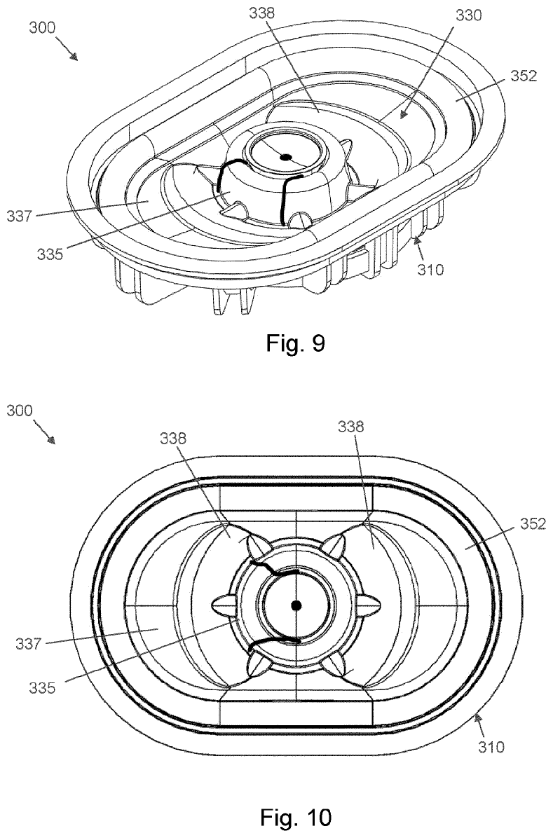

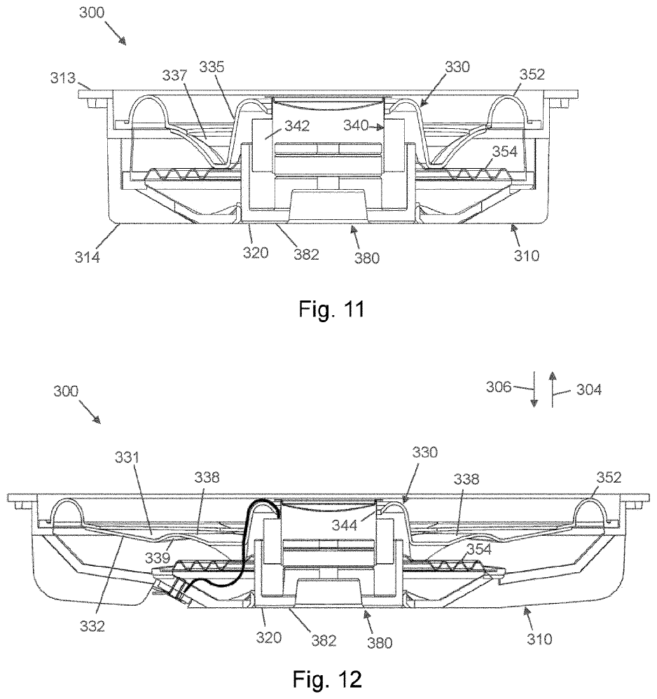

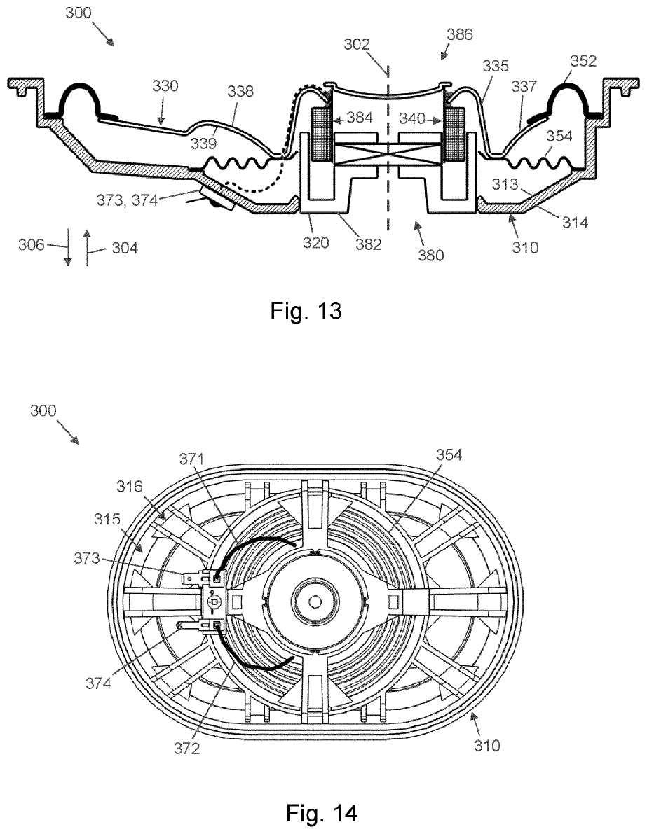

FIGS. 9 to 14 show another exemplary loudspeaker 300. FIG. 9 is a (front) perspective view of the loudspeaker 300. FIG. 10 is a (front) plan view of the loudspeaker 300. FIG. 11 is a first sectional view of the loudspeaker 300, while FIG. 12 is a second sectional view of the loudspeaker 300. FIG. 13 is a combined cross-sectional view of the loudspeaker 300, combining (part of) FIGS. 11 and 12. FIG. 14 is a (rear) plan view.

Some of the features of the loudspeaker 300 are similar to corresponding features of the loudspeaker 200 described above. Detailed description of these features is therefore omitted.

The loudspeaker 300 defines a movement axis 302 (shown in FIG. 13) and includes a frame 310, a magnet unit 320, a diaphragm 330, and a voice coil assembly 340. The voice coil assembly 340 includes a voice coil 342 and a voice coil former 344.

The frame 310 has a front side 313 facing a first direction 304 and a back side 314 facing in a second direction 306. The diaphragm 330 is suspended from the frame 310 on the front side 313 of the frame 310 by at least a first suspension element 352 and a second suspension element 354. The second suspension element 354 is located between the frame 310 and the diaphragm 330.

The frame 310 has a plurality of apertures 315 which extend from the front side 313 to the back side 314 of the frame 310. The frame 310 comprises a plurality of ribs 316 defining the plurality of apertures 315. The diaphragm 330 has a first radiating surface 331 facing in the first direction 304 and a second radiating surface 332 facing in the second direction 306.

The loudspeaker 300 includes a pair of lead wires 371, 372 terminating at a respective terminal 373, 374. The loudspeaker 300 includes a drive unit 380 including a stationary part 382 attached to the frame 310, and a translatable part 384 attached to the diaphragm 330 to form a moving assembly 386. In some examples, the stationary part 382 includes the magnet unit 320, while the translatable part 384 includes the voice coil assembly 340.

The inventors believe that it may be an accepted teaching in the art that stiffness is a desirable property of the diaphragm 330 and that increasing the diaphragm angle may contribute to increased geometrical stiffness of the diaphragm 330. Here, the diaphragm angle is measured relative to a plane perpendicular to the movement axis 300. A very small diaphragm angle would therefore mean that the diaphragm 330 is close to perpendicular to the movement axis 302, whereas a very large diaphragm angle would mean that the diaphragm 330 is close to parallel to the movement axis 302.

The diaphragm 330 includes an inner diaphragm portion 335 and an outer diaphragm portion 337. The diaphragm 330 is suspended from the frame 310 by at least a first suspension element 352 and a second suspension element 354. The first suspension element 352 is attached to the outer diaphragm portion 337. The second suspension element 354 is attached to the diaphragm 330. More particularly, in some examples the second suspension element 354 is attached to the diaphragm 330 at a location between the inner diaphragm portion 335 and the outer diaphragm portion 337.

In the racetrack configuration of FIGS. 9 to 14, the long section has a small diaphragm angle while the short section has a large diaphragm angle. In other words, the outer diaphragm portion 337 is steeper at the short section of the racetrack loudspeaker 300 than at the long section of the racetrack loudspeaker 300. The outer diaphragm portion 337 has a larger diaphragm angle for the short section than for the long section. More generally, when enlarging the outer size of the diaphragm 330 in one direction, e.g. in the present racetrack configuration, or in all directions, e.g. in a round configuration, the outer diaphragm angle will decrease and, furthermore, the outer diaphragm portion 337 may also interfere with the second suspension element 354 during operation.

The inventors note that it may be possible to increase the outer diaphragm angle by making the whole loudspeaker higher, however doing so may conflict with loudspeaker designs having a shallow package whilst allowing for large excursions. The inventors therefore provided an arch portion 338 (or ‘bulge’) in the outer diaphragm portion 337. The arch portion 338 is located where interference with the second suspension element 354 would occur during operation. That is to say, the arch portion 338 is configured such that an underside 339 of the first arch portion 338 avoids contact with the second suspension element 354 by arching over the second suspension element 354 when the diaphragm 330 is at its maximum extent in the second direction when the loudspeaker 300 is in use. In other words, the underside 339 of the arch portion 338 defines a recess (or ‘channel’) in which the second suspension element 354 is locatable during operation such that contact with the diaphragm 330 may be prevented.

The arch portion 338 may not only solve the problem of interference with the second suspension element 354 but may also serve to reinforce the diaphragm 330 since the bulge 338 is expected to increase geometrical stiffness.

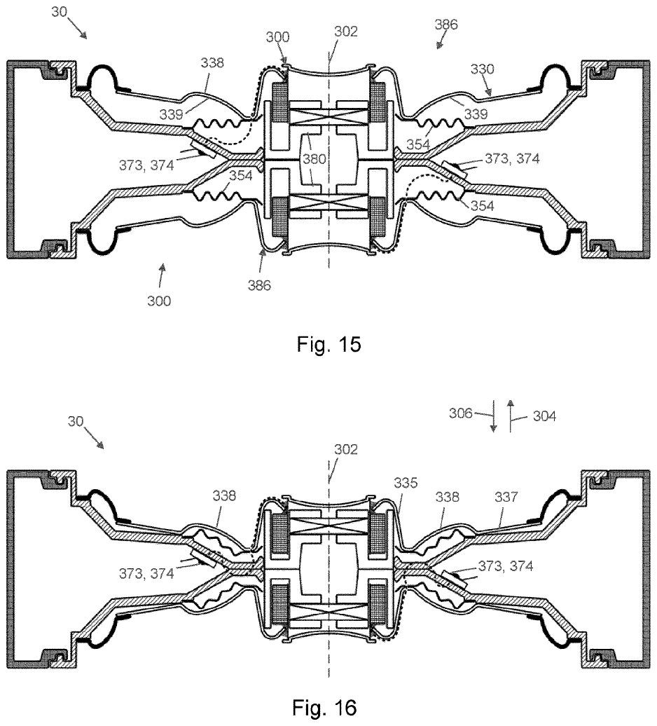

FIGS. 15 and 16 shows the loudspeaker 300 as part of a system 30 wherein multiple loudspeakers 300 are provided in a force-cancelled arrangement. FIG. 15 is a first cross-sectional view showing the loudspeaker system 30 at rest, while FIG. 16 is a second cross-sectional view of the loudspeaker system 30 at maximum negative displacement.

The loudspeaker system 30 includes a first loudspeaker 300 and a second loudspeaker 300 in back-to-back configuration such that the first loudspeaker 300 and the second loudspeaker 300 face in opposite directions. The loudspeaker system 30 is operable to energise the drive units 380 of the first loudspeaker 300 and the second loudspeaker 300 to cause the moving assemblies 386 of the first loudspeaker 300 and the second loudspeaker 300 to move along the movement axis 302 in opposite directions, thereby moving the diaphragm 330 of the first loudspeaker 300 and the diaphragm 330 of the second loudspeaker 300 to produce sound.

As can be seen in FIG. 16, the second suspension element 354 is located at the underside 339 of the arch portion 338 when the loudspeaker system 30 is at maximum negative displacement. That is to say, each arch portion 338 is configured such that the underside 339 of the arch portion 338 avoids contact with the second suspension element 354 by arching over the second suspension element 354 when the diaphragm 330 of the first loudspeaker 300 is at its maximum extent in the second direction 306 and the diaphragm 330 of the second loudspeaker 300 is at its maximum extent in the first direction 304.

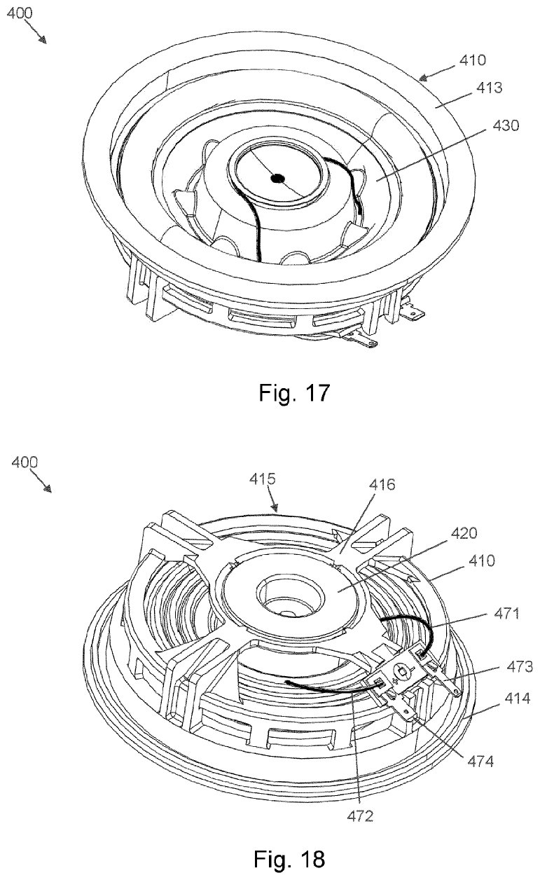

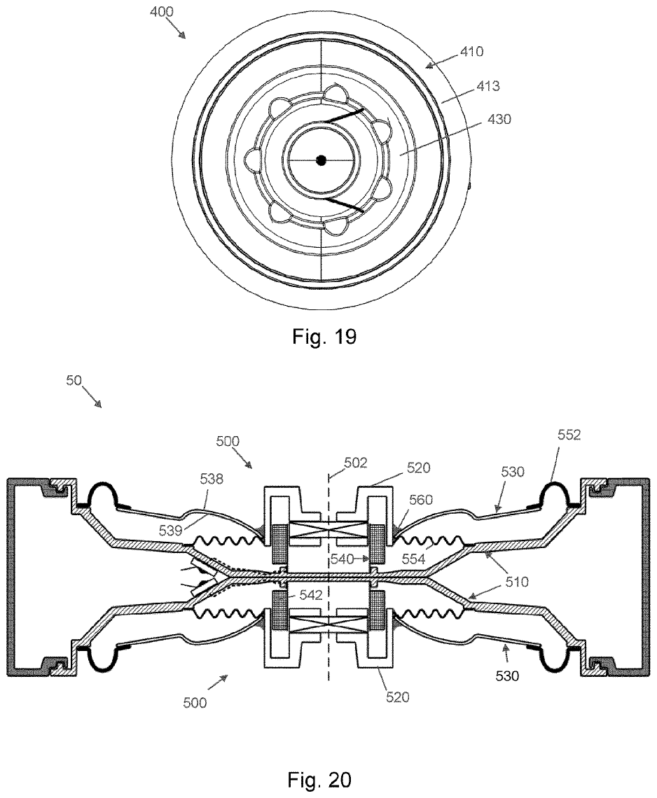

FIGS. 17, 18 and 19 show another exemplary loudspeaker 400. FIG. 17 is a front perspective view, while FIG. 18 is a rear perspective view, and FIG. 19 is a front view of the loudspeaker 400. Some of the features of the loudspeaker 400 are similar to corresponding features of the loudspeakers 200, 300 described above. Detailed description of these features is therefore omitted.

The loudspeaker 400 includes a frame 410, a magnet unit 420, a diaphragm 430, and a voice coil assembly.

The frame 410 has a front side 413 facing a first direction and a back side 414 facing in a second direction.

The frame 410 comprises a plurality of ribs 416 defining a plurality of apertures 415. The apertures 415 extend from the front side 413 to the back side 414 of the frame 410.

The loudspeaker 400 includes a pair of lead wires 471, 472 terminating at a respective terminal 473, 474. The loudspeaker 400 may be provided as part of a loudspeaker system in back-to-back configuration. For example, a first loudspeaker 400 and a second loudspeaker 400 may be arranged in back-to-back configuration such that the first loudspeaker 400 and the second loudspeaker 400 face in opposite directions. The loudspeakers 400 may be arranged such that the lead wires 471, 472 are offset and do not in use touch, even when being displaced from the contours of the respective loudspeaker 400 at maximum displacement.

The voice coil assembly includes a voice coil which may have a mass that 1.75 times the mass of a permanent magnet of the magnet unit 420.

The magnet unit 420 may form an airgap with a magnetic reluctance of 5.3×10\hat{ }6 [1/Henry].

The loudspeaker 400 may have a ratio of moving mass to total mass of approximately 1:4, e.g., approximately 40 grams:160 grams.

The loudspeaker 400 may have a total height of approximately 30.5 millimetres and a total outer diameter of approximately 114 millimetres. As such, the loudspeaker 400 may be considered a small (bass) loudspeaker (where provided as a bass loudspeaker).

FIG. 20 is a cross-sectional view of an exemplary loudspeaker system 50. The loudspeaker system 50 includes a pair of loudspeakers 500 in back-to-back configuration and facing in opposite directions.

Each loudspeaker 500 includes a frame 510, a magnet unit 520, a diaphragm 530, and a voice coil assembly 540.

The diaphragm 530 is suspended from the frame 510 by at least a first suspension element 552 and a second suspension element 554. The first suspension element 552 is attached to the frame 510 at a first landing surface on the frame 510 and the second suspension element 554 is attached to the frame 510 at a second landing surface on the frame 510.

The loudspeaker system 50 is operable to energise a voice coil 542 of the first loudspeaker 500 and a voice coil 542 of the second loudspeaker 500 to cause the magnet unit 520 of the first loudspeaker 500 and the magnet unit 520 of the second loudspeaker 500 to move along the movement axis 502 in opposite directions, thereby moving the diaphragm 530 of the first loudspeaker 500 and the diaphragm 530 of the second loudspeaker 500 to produce sound.

An arch portion 538 (or ‘bulge’) is formed in diaphragm 330. The arch portion 538 is located where interference with the second suspension element 554 would otherwise occur during operation. That is to say, the arch portion 538 is configured such that an underside 538 of the arch portion 538 avoids contact with the second suspension element 554 by arching over the second suspension element 554 when the diaphragm 530 is at its maximum extent in the second direction when the loudspeaker system is in use. In some examples, the diaphragm 530 is joined directly to the magnet unit 520. More particularly, a body 560 of hardened adhesive bonds the diaphragm 530 and the magnet unit 520. Here, the arch portion 538 is bonded to the magnet unit 520. Similarly, the second suspension element 554 is joined directly to the magnet unit 520.

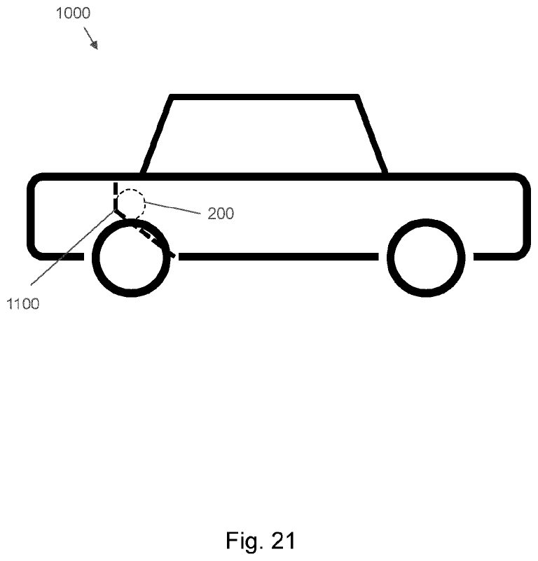

FIG. 21 is a schematic view of an automobile 1000 including a loudspeaker or loudspeaker system as described above, in this example the loudspeaker 200. Any exemplary loudspeaker or loudspeaker system as described above may be installed in the automobile 1000. In this example, the loudspeaker system 200 described above is provided between the footwells 1100 of the automobile 1000. Other locations are also envisaged.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. A loudspeaker including:
a frame;
a magnet unit secured to the frame to guide magnetic flux across an air gap;
a diaphragm suspended from the frame;
wherein the diaphragm includes a neck portion forming a diaphragm aperture;
a voice coil assembly including a voice coil and a voice coil former;
wherein the voice coil former extends through the diaphragm aperture such that a first gap is formed between the voice coil former and the neck portion of the diaphragm and a second gap is formed between the neck portion and the voice coil;
a body of hardened adhesive which occupies the first gap between the voice coil former and the neck portion of the diaphragm and the second gap between the neck portion and the voice coil;
wherein the loudspeaker is operable to energise the voice coil to cause the voice coil assembly to move relative to the magnet unit along a movement axis, thereby moving the diaphragm along the movement axis to produce sound.

2. The loudspeaker according to claim 1, wherein
the second gap has a gap size measured in a direction parallel to the movement axis which is between 0 and 5 millimetres.

3. The loudspeaker according to claim 1, wherein
the first gap has a gap size measured in a direction perpendicular to the movement axis which is at least 1 millimetre.

4. The loudspeaker according to claim 3, wherein
the gap size of the first gap is at most 50 percent of the winding thickness of the voice coil.

5. The loudspeaker according to claim 1,
wherein the diaphragm includes an inner diaphragm portion and a curved segment between the neck portion and the inner diaphragm portion;
wherein the curved segment has a radius of curvature between 2 and 10 mm.

6. The loudspeaker according to claim 1,
wherein the diaphragm includes an inner diaphragm portion and a curved segment between the neck portion and the inner diaphragm portion;
wherein the curved segment has a first length which is measured along the diaphragm and perpendicular to the movement axis;
the neck portion has a second length which is measured along the diaphragm and perpendicular to the movement axis; and
the first length is greater than the second length.

7. The loudspeaker according to claim 1, wherein the body of hardened adhesive has a volume 30 cubic millimetres to 100 cubic millimetres per millimetre of voice coil diameter.

8. A loudspeaker system including a first loudspeaker and a second loudspeaker;
wherein the first loudspeaker includes:
a frame;
a magnet unit secured to the frame to guide magnetic flux across an air gap;
a diaphragm suspended from the frame;
wherein the diaphragm includes a neck portion forming a diaphragm aperture;
a voice coil assembly including a voice coil and a voice coil former;
wherein the voice coil former extends through the diaphragm aperture such that a first gap is formed between the voice coil former and the neck portion of the diaphragm and a second gap is formed between the neck portion and the voice coil;
a body of hardened adhesive which occupies the first gap between the voice coil former and the neck portion of the diaphragm and the second gap between the neck portion and the voice coil;
wherein the loudspeaker is operable to energise the voice coil to cause the voice coil assembly to move relative to the magnet unit along a movement axis, thereby moving the diaphragm along the movement axis to produce sound;
wherein the second loudspeaker includes:
a frame;
a magnet unit secured to the frame to guide magnetic flux across an air gap;
a diaphragm suspended from the frame;
wherein the diaphragm includes a neck portion forming a diaphragm aperture;
a voice coil assembly including a voice coil and a voice coil former;
wherein the voice coil former extends through the diaphragm aperture such that a first gap is formed between the voice coil former and the neck portion of the diaphragm and a second gap is formed between the neck portion and the voice coil;
a body of hardened adhesive which occupies the first gap between the voice coil former and the neck portion of the diaphragm and the second gap between the neck portion and the voice coil;
wherein the loudspeaker is operable to energise the voice coil to cause the voice coil assembly to move relative to the magnet unit along a movement axis, thereby moving the diaphragm along the movement axis to produce sound;
wherein the first loudspeaker and the second loudspeaker are arranged in back-to-back configuration such that the first loudspeaker and the second loudspeaker face in opposite directions;
wherein the loudspeaker system is operable to energise the voice coil of the first loudspeaker and the voice coil of the second loudspeaker to cause the voice coil of the first loudspeaker and the voice coil of the second loudspeaker to move along the movement axis in opposite directions, thereby moving the diaphragm of the first loudspeaker and the diaphragm of the second loudspeaker to produce sound.

9. A method of manufacturing a moving assembly for a loudspeaker, including:
providing a voice coil assembly including a voice coil former and a voice coil;
providing a diaphragm including a neck portion forming a diaphragm aperture;
fitting the diaphragm onto the voice coil assembly by inserting the voice coil former through the diaphragm aperture;
curing a portion of adhesive to form a body of hardened adhesive which occupies a first gap between the voice coil former and the neck portion of the diaphragm and a second gap between the neck portion and the voice coil so as to attach the neck portion of the diaphragm to the voice coil former.

10. The method of manufacturing according to claim 9,
wherein fitting the diaphragm onto the voice coil assembly is followed by applying a bead of adhesive at a gap formed between the voice coil former and the neck portion.

11. The method of manufacturing according to claim 9,
wherein fitting the diaphragm onto the voice coil assembly is preceded by applying a bead of adhesive along a junction formed between the voice coil former and the voice coil.

12. A loudspeaker system including:
a first loudspeaker comprising:
a first frame having a back side and a front side, wherein the first frame has a plurality of first apertures which extend from the front side to the back side of the first frame;
a first diaphragm suspended from the first frame on the front side of the first frame;
a first drive unit, wherein the first drive unit includes a stationary part attached to the first frame and a translatable part, and the translatable part of the first drive unit is attached to the first diaphragm to form a first moving assembly; and
at least two first lead wire portions configured to transmit an electrical signal between the first drive unit and a signal source;
wherein, when the first loudspeaker is at rest, the at least two first lead wire portions extend between the first diaphragm and the first frame;
a second loudspeaker comprising:
a second frame having a back side and a front side, wherein the second frame has a plurality of second apertures which extend from the front side to the back side of the second frame;
a second diaphragm suspended from the second frame on the front side of the second frame;
a second drive unit, wherein the second drive unit includes a stationary part attached to the second frame and a translatable part, and the translatable part of the second drive unit is attached to the second diaphragm to form a second moving assembly; and
at least two second lead wire portions configured to transmit an electrical signal between the second drive unit and the signal source;
wherein, when the second loudspeaker is at rest, the at least two second lead wire portions extend between of the second diaphragm and the second frame;
wherein the loudspeaker is operable to energise the first drive unit and the second drive unit to cause the first moving assembly and the second moving assembly to move along a movement axis in opposite directions to produce sound; and
wherein all of the first lead wire portions are offset from all of the second lead wire portions when viewed in a plane perpendicular to the movement axis.

13. The loudspeaker system according to claim 12,
wherein the first frame comprises a plurality of ribs defining the plurality of first apertures, and the second frame comprises a plurality of ribs defining the plurality of second apertures.

14. The loudspeaker system according to claim 12,
wherein there are exactly two first lead wire portions and exactly two second lead wire portions.

15. The loudspeaker system according to claim 12, wherein
each of the two first lead wire portions terminate at a respective first terminal on the first frame,
each of the two second lead wire portions terminate at a respective second terminal on the second frame.

16. The loudspeaker system according to claim 15, wherein each of the first and second terminals is offset from all other of the first and second terminals by an angle of at least 10 degrees, preferably at least 20 degrees, measured relative to the movement axis when viewed in a plane perpendicular to the movement axis.

17. A loudspeaker system, comprising:
a first loudspeaker including:
a first frame having a front side facing in a first direction and a back side facing in a second direction;
a first diaphragm suspended from the first frame on the front side of the first frame by at least a first suspension element and a second suspension element, wherein the second suspension element is located between the first frame and the first diaphragm;
a first drive unit including a first stationary part attached to the first frame, and further including a first translatable part attached to the first diaphragm to form a first moving assembly;
wherein the first diaphragm has a first radiating surface facing in the first direction and a second radiating surface facing in the second direction;
wherein the first diaphragm includes a first arch portion which extends in the first direction and is configured such that the underside of the first arch portion avoids contact with the second suspension element by arching over the second suspension element when the first diaphragm is at its maximum extent in the second direction when the loudspeaker system is in use;
a second loudspeaker including:
a second frame having a front side facing in the second direction and a back side facing in a first direction;
a second diaphragm suspended from the second frame on the front side of the second frame by at least a third suspension element and a fourth suspension element, wherein the fourth suspension element is located between the second frame and the second diaphragm;
a second drive unit including a second stationary part attached to the second frame, and further including a second translatable part attached to the second diaphragm to form a second moving assembly;
wherein the second diaphragm has a first radiating surface facing in the second direction and a second radiating surface facing in the first direction;
wherein the second diaphragm includes a second arch portion which extends in the second direction and is configured such that the underside of the second arch portion avoids contact with the fourth suspension element by arching over the fourth suspension element when the second diaphragm is at its maximum extent in the first direction when the loudspeaker system is in use;
wherein the loudspeaker is operable to energise the first drive unit and the second drive unit to cause the first moving assembly and the second moving assembly to move along a movement axis in opposite directions to produce sound.

18. The loudspeaker according to claim 1, wherein:
the magnet unit includes a permanent magnet,
the permanent magnet has a first mass, the voice coil has a second mass, and the first mass is smaller than the second mass; and/or
the air gap has a magnetic reluctance of at least 2×10\hat{ }6 [1/H]; and/or
the loudspeaker or the loudspeaker system is provided as a subwoofer configured to produce sound with frequencies in a bass frequency range, the bass frequency range including 60-80 Hz; and/or
the diaphragm is suspended from the frame by at least a first suspension element and a second suspension element, and wherein the entire voice coil is positioned between the first suspension element and the second suspension element.

19. The loudspeaker system according to claim 12,
wherein the or each drive unit includes a permanent magnet and a voice coil,
wherein the permanent magnet has a first mass, the voice coil has a second mass, and the first mass is smaller than the second mass; and/or
the drive unit forms an air gap which has a magnetic reluctance of at least 2×10\hat{ }6 [1/H]; and/or
the first diaphragm is suspended from the first frame by at least a first suspension element and a second suspension element, wherein the translatable part includes either a voice coil or a magnet unit, and wherein the entire voice coil or the entire magnet unit is positioned between the first suspension element and the second suspension element.

20. (canceled)

21. (canceled)

22. (canceled)

23. The loudspeaker system according to claim 17, wherein the entire voice coil is positioned between the first suspension element and the second suspension element.

24. (canceled)

25. (canceled)

26. (canceled)
